(19) United States
(12) Patent Application Publication
(10) Pub. No.: US 2003/0097274 A1
(43) Pub. Date: May 22, 2003

(54) Method and system for compiling, displaying, and updating travel information

(76) Inventor: Thomas W. Parsons, Mansfield, TX (US)

Correspondence Address: ARTER & HADDEN, LLP, 1100 HUNTINGTON BUILDING, 925 EUCLID AVENUE, CLEVELAND, OH, 44115-1475, US

(21) Appl. No.: 10/299,355

(22) Filed: Nov. 18, 2002

Related U.S. Application Data
(60) Provisional application No. 60/332,577, filed on Nov. 16, 2001.

(51) Int. Cl. G06F 17/60

(52) U.S. Cl. 705/1; 705/5

(57) ABSTRACT

This invention is directed to a method and system for querying fare and rate information to find the lowest fares or rates and providing such information to end users. This invention is further directed to a method and system for determining when to update a reservation system database. Also disclosed is a method and system for updating reservation systems databases with the most recent reservation information.

### CROSS-REFERENCE TO RELATED APPLICATIONS.

This application claims the benefit of U.S. Provisional Application No. 60/332,577, filed on Nov. 16, 2001.

### BACKGROUND OF THE INVENTION

This invention pertains generally to the travel industry, and more specifically to a method and system for compiling, displaying, and updating information relating to travel fares, such as airline fares, hotel rates, and car rental rates.

Airline companies collaborate to provide the Airline Tariff Publishing Company (“ATPCO”). ATPCO provides its members with a large amount of information relating to the International Fares System; US/Canada Fares System; Automated Rules System; Routing System; US/Canada Joint Fares System; Cargo Rates System; Auto Rates System; Online; International Fares Subscriptions; US/Canada Fares and Footnotes; Automated Rules Products; Fare Rules Routings and many other products and services.

Reservation systems acquire information relating to fares and rules from ATPCO and others and correlate that information with information relating to passenger availability. Reservation systems (“RS”) then provide services for travel agents, who in turn provide services for end users. As information becomes increasingly accessible via the Internet, there is an increasing demand for online availability of reservation systems. Accordingly, a number of online services are now available which query reservations and provide feedback directly to end users or consumers. However, there is a need for a method and system for quickly and efficiently querying fare and rate information to find the lowest fares and providing such information to end users. There is also a need for system and method to quickly and efficiently obtain updates to fare and rate information.

### SUMMARY OF THE INVENTION

In accordance with the present invention, there is provided a method and system for querying reservation information and providing feedback to end users and for updating such information.

Further, in accordance with the present invention, there is provided a method and system for querying fare and rate information to find the lowest fares or rates and providing such information to end users.

Further, in accordance with the present invention, there is provided a method and system for determining when to update a reservation system database.

Still further, in accordance with the present invention, there is provided a method and system for updating reservation systems databases with the most recent reservation information.

Still further, in accordance with the present invention, there is provided a method and system for querying and displaying airline fare information comprising the steps of and the means adapted for: receiving an origin location and a destination location; selectively querying at least one database for fares representing the received origin and destination location combination; displaying fare information for the received origin location and destination location combination; determining whether an alternate location is available; selecting at least one alternate location upon determining that at least one alternate location is available; and displaying fare information for at least one location combination comprising the least one alternate location.

Still further, in accordance with the present invention, there is provided a method and system for querying and displaying travel rate information for at least one of hotel rates and car rental rates comprising the steps of and means adapted for: selecting a travel destination; selectively querying at least one database for rates associated with the selected destination; displaying selected information relating to fares associated with the selected destination; determining whether at least one alternate location is available; based on a positive determination that at least one alternate location is available, selecting at least one alternate location; selectively querying at least one database for fares associated with the destination location and at least one alternate location combination; and displaying selected information relating to fares associated with at least one location combination comprising the least one alternate location.

Still further, in accordance with the present invention, there is provided a method and system for monitoring updates to a reservation system database comprising the steps and means adapted for: selecting at least one representative location; selectively querying the reservation system database at predetermined intervals for at least one of fares associated with at least one destination; determining if the fares received from the most recent query are the same as fares received from the next most recent query; based on a negative determination, updating a local copy of the reservation system database with selected information about the new fares.

Still further, in accordance with the present invention, there is provided a method and system for updating information in at least one reservation system database comprising the steps and means adapted for: selecting an origin location; selectively querying at least one reservation system server for fares for all destination locations originating from the origin location; selectively querying at least one reservation system server for fares departing from the origin location; determining whether, for each destination location, if a query of the reservation system server has been performed for fares from the destination location to the origin location; based on a negative determination that the reservation system server has been queried for fares from the destination location to the first location, storing selected fare information received from the selective query of for fares departing from the origin location in the reservation system database; based on a positive determination that the reservation system server has been queried, determining whether the fare received for the origin location to the destination location is the same as the fare received for the destination location to the origin location; and based on a negative determination that the fares are the same, storing selected fare information received from the selective query of for fares departing from the origin location for in the reservation system database.

These and other advantages, aspects, and features will be understood by one of ordinary skill in the art upon reading and understanding the specification.

### BRIEF DESCRIPTION OF THE DRAWINGS

FIG. 1 is a diagram representing a system for providing end users with access to information relating to travel fares;

FIG. 2 is a flow chart representing a method for displaying at least one low fare corresponding to an input request by a user;

FIG. 3 is a flow chart representing a method for displaying at least one travel fare corresponding to an input request by a user;

FIG. 4 is a flow chart representing the method for querying multiple information sources in order to retrieve at least one low fare for displaying to a user;

FIG. 5 is an example of a portion of a web page for displaying query results responsive to user input;

FIG. 6 is a flow chart representing a method for determining when to update information stored in the RS database with information from one of the RS servers;

FIG. 7 is a flow chart representing a method for updating information in the RS database with information from at least one of the RS servers;

FIG. 8 is an alternate embodiment of invention as shown in FIG. 1; and

FIG. 9 is an alternate embodiment of invention as shown in FIG. 2.

### DETAILED DESCRIPTION OF THE PREFERRED EMBODIMENTS

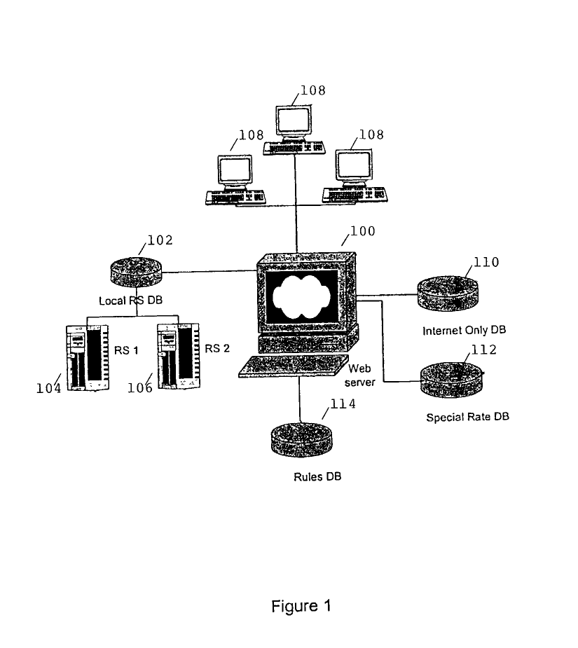

Turning to FIG. 1, there is provided a diagram of a system for compiling and providing information relating to travel fares, such as airline fares, hotel rates, and car rental rates. The system is suitably a network system and preferably comprises a web server 100 that is accessible to end user machines 108 via the Internet. The web server 100 preferably provides access to information stored in at least one database by providing information that is accessible from an Internet browser program such as Netscape or Internet Explorer. Preferably, the web server 100 comprises markup language based web pages (i.e. HTML, XML, etc.) and server pages (i.e. JSP, ASP, etc.).

Communicatively coupled to web server 100 is an RS database 102. The RS database 102 is suitably any database for storing information received from at least one RS server 104 or 106. Preferably, the RS database 102 is a relational database comprising multiple interrelated tables that store information retrieved from querying at least one RS server 104 or 106. The RS database is suitably a set of tables residing either on the web server 100 or on an independent server. In addition, the RS database 102 suitably comprises separate databases designed to store information retrieved from separate RS servers 104 and 106. Furthermore, the RS database suitably comprises separate database servers each configured to store information from separate RS servers 104 and 106.

Also communicatively coupled to web server 100 is an Internet only database 110 for storing Internet only fares offered from various airlines, hotels, and car rental agencies. The Internet only database 110 is suitably any database for storing information relating to Internet only fares offered by at least one airline, hotel, or car rental agency. Regarding air fares, preferably, the Internet only database 110 contains information relating to all domestic airlines and at least a subset of the international airlines. Preferably, the Internet only database 110 is a relational database comprising multiple interrelated tables that store information relating to Internet only fares. The Internet only database 110 is suitably a set of tables residing either on the web server 100 or on an independent server. In addition, the Internet only database 110 suitably comprises separate databases designed to store information regarding Internet only fares from separate airlines, hotels, and car rental agencies. In addition, the Internet only database 110 suitably comprises separate database servers each configured to store Internet only fare information from separate airlines, hotels, and car rental agencies.

Likewise, communicatively coupled to the web server 100 is a special rate database 112 for special fares and contract prices offered by airlines, hotels, and car rental agencies to the provider of the services available via the web server 100. Special fare information stored on the special fare database suitably comprises percentage discount information, special pricing, promotions etc. Preferably, the special rate database 112 is a relational database comprising multiple interrelated tables that store information relating to special fares. The special rate database 112 is suitably a set of tables residing either on the web server 100 or on an independent server. In addition, the special rate database 112 suitably comprises separate databases designed to store information regarding special rate fares from separate airlines, hotels, and car rental agencies. Also, the special rate database 112 suitably comprises separate database servers each configured to store special rate fare information from separate airlines, hotels, and car rental agencies.

Also communicatively coupled to the web server 100 is a rules database 114 for storing the rules associated with various fare codes or rate codes. When a reservation system is queried, fare information obtained comprises a fair code for each fare or rate. Associated with fare codes are sets of rules that further limit the availability of the fare or rate. Such rule information associated with fare codes is stored in the rules database 114. Preferably, the rules database 114 is a relational database comprising multiple interrelated tables that store information relating to rules corresponding to fare codes or rate codes. The rules database 114 is suitably a set of tables residing either on the web server 100 or on an independent server. In addition, the rules database 114 suitably comprises separate databases designed to store information regarding rules from separate airlines, hotels, and car rental agencies. Such rules include, but are not limited to, day of travel restrictions, time restrictions, seasonal restrictions, blackout periods, minimum stay requirements, maximum stay requirements, advance purchase requirements, stopovers, and senior fares. The rules database 114 also suitably comprises separate database servers each configured to store rule information from separate airlines, hotels, and car rental agencies. Preferably, the rules database 114 stores information relating to fares, schedules, and rules for flights up to 330 days in the future.

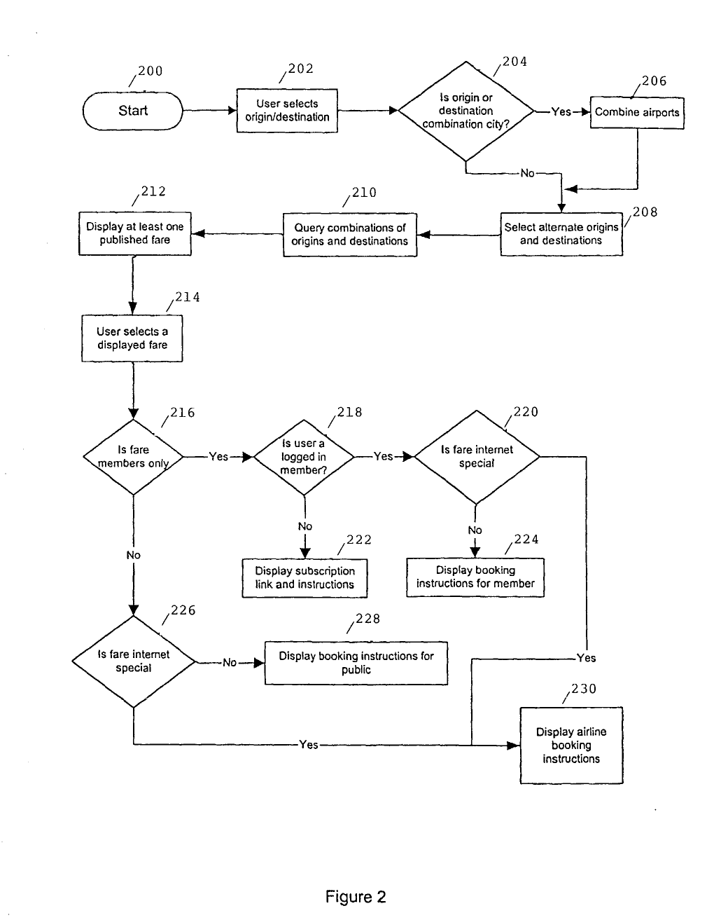

Turning now to FIG. 2, a flow chart representing a method for displaying at least one low airline fare corresponding to an input request by a user is disclosed. The basic flow commences at start block 200, from which progress is made to process block 202 where a user selects an origin and a destination on a web page. Flow then proceeds to decision block 204 where a determination is made whether either the selected origin or destination city are combination locations.

Combination locations are those cities in which multiple airports within close proximity to one another are considered one destination. One such exemplary combination location is Chicago where two airports are not distinguished. In such cases, an RS converts the airport codes from both airports to one location code. Therefore, it is possible for a user to query an RS for a fare from city A to Midway airport in Chicago, and have the RS provide fare information for a flight only available to O'Hare airport.

Therefore, upon a positive determination in decision block 204, flow progresses to process block 206 where the airport codes for multiple airports in a combination location are combined into a single location code. Flow then proceeds to process block 208 where alternate origins and destinations are retrieved. Upon a negative determination at decision block 204, flow progresses directly to process block 208. Alternate origins and destinations are those locations within close proximity such that a user may desire to travel to the alternate location in order to reduce airfare. The alternate locations retrieved in process block 208 are suitably preselected and stored in a locations table or database or determined based on distance or time criteria either entered by the user or automated by the system. In a presently preferred embodiment, five alternate locations are selected, however any number of locations are within the scope of the present invention. Also, in a presently preferred embodiment, the alternate locations are selected without forcing the user to enter any additional information.

Flow then proceeds to process block 210 where fare for all combinations from the list of origin and alternate origin locations to the destination and alternate destinations are queried. If the desired fare is one-way, then fares from all origin locations to all destination locations are queried. If the desired fare is round-trip, then the fares are queried such that the destination location of the first trip is the origin location of the return trip and origin location of the first trip is destination location of the return trip. After querying the fares for the various combinations of locations, at least one published fare is displayed for the user in process block 212.

Flow proceeds to process block 214 where a user then selects a displayed fare. Once the user selects a displayed fare, flow progresses to decision block 216 where a determination is made whether the selected fare is a members only fare. A negative determination at decision block 216 causes progression to decision block 226 where a determination is made whether the fare selected at process 214 is an Internet only fare. Upon a negative determination at decision block 226, flow progresses to process block 228 where instructions for booking the fare are displayed for the non-member user. A positive determination at decision block 226 causes progression to process block 230 where the instructions specific to a particular airline's Internet only fare are displayed for the user. The display of the Internet only fare booking instructions is suitably accomplished by linking the user to the airline's web site for booking the fare.

Upon a positive determination at decision block 216, flow progresses to decision block 218 where a determination is made whether the user is logged in as a member. Upon a negative determination at decision block 218 causes progression to decision block 222 where instructions for becoming a member are displayed for the user.

A positive determination at decision block 218 causes progression to decision block 220 where a determination is made whether the fare is an Internet only fare. Upon a negative determination at decision block 220, progression is made to process block 224 where instructions for booking the fare are displayed for the member user. A positive determination at decision block causes progression to process block 230 where the instructions specific to a particular airline's Internet only fare are displayed for the user as described above.

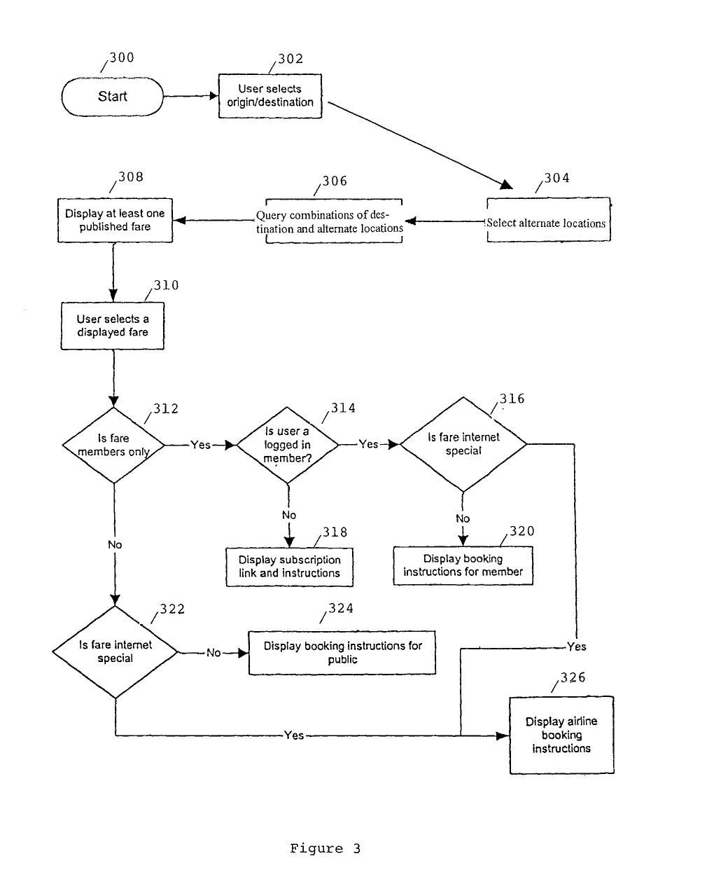

Referring to FIG. 3, a flow chart representing a method for displaying at least one low fare for at least one of hotels and car rental agencies corresponding to an input request by a user is disclosed. The basic flow commences at start block 300, from which progress is made to process block 302 where a user selects a travel destination on a web page.

Flow then proceeds to process block 304 where alternate locations are retrieved. Alternate locations are those locations within close proximity such that a user may desire to travel to the alternate location in order to reduce the rates. The alternate locations retrieved in process block 304 are suitably preselected and stored in a locations table or database or determined based on distance or time criteria either entered by the user or automated by the system. In a presently preferred embodiment, five alternate locations are selected, however any number of locations are within the scope of the present invention. Also, in a presently preferred embodiment, the alternate locations are selected without forcing the user to enter any additional information.

Flow then proceeds to process block 306 where fare for all combinations of the selected destination and alternate locations are queried. After querying the fares for the various combinations of locations, at least one published fare is displayed for the user in process block 308.

Flow proceeds to process block 310 where a user then selects a displayed fare. Once the user selects a displayed fare, flow progresses to decision block 312 where a determination is made whether the selected fare is a members only fare. A negative determination at decision block 312 causes progression to decision block 322 where a determination is made whether the fare selected at process 310 is an Internet only fare. Upon a negative determination at decision block 322, flow progresses to process block 324 where instructions for booking the fare are displayed for the non-member user. A positive determination at decision block 322 causes progression to process block 326 where the instructions specific to a particular entities' Internet only fare are displayed for the user. The display of the Internet only fare booking instructions is suitably accomplished by linking the user to the entities' web site for booking the fare.

Upon a positive determination at decision block 312, flow progresses to decision block 314 where a determination is made whether the user is logged in as a member. Upon a negative determination at decision block 314 causes progression to decision block 318 where instructions for becoming a member are displayed for the user.

A positive determination at decision block 314 causes progression to decision block 316 where a determination is made whether the fare is an Internet only fare. Upon a negative determination at decision block 316, progression is made to process block 320 where instructions for booking the fare are displayed for the member user. A positive determination at decision block causes progression to process block 326 where the instructions specific to a particular airline's Internet only fare are displayed for the user as described above.

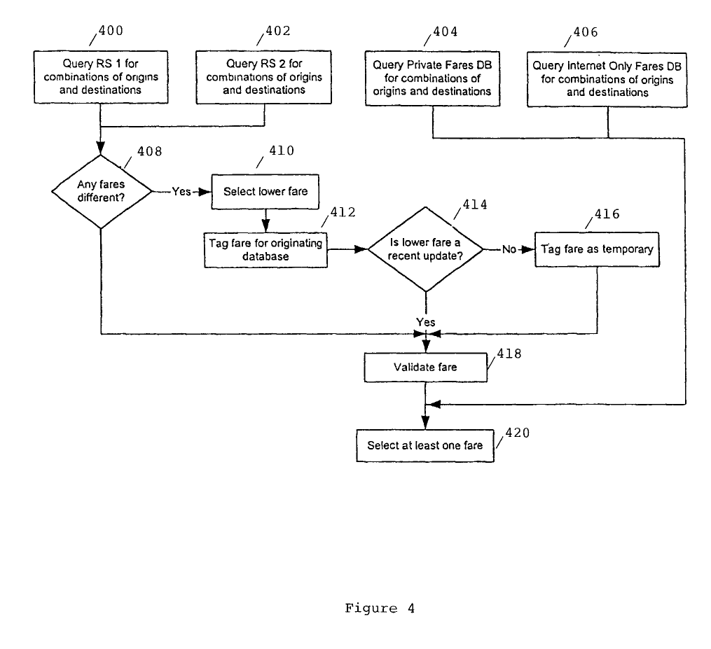

Turning now to FIG. 4, a block diagram representing a method for querying multiple information sources in order to retrieve at least one low fare for displaying to a user is disclosed. In order to provide the lowest possible fare to end users, it is necessary to gather information from a variety of sources. Because RS servers get their fare information from the same source, such as ATPCO, when they are all updated with current information, they each provide the same information. However, different RS servers get information updates at different times during the day. Generally, RS servers update fare information three times each day during the week and once each day on the weekends. Because the update times are different for various RS servers, fares available on one RS server are not available on other RS servers. Therefore, in order to find lowest available fare, more than one RS is queried.

After a user submits an origin and destination location and the alternate locations are determined, RS 1 information is queried for public fares to appropriate origins and destinations in process 400. Concurrently, the same query is performed on RS 2 information in process 400. The RS 1 and RS 2 information are suitably stored on separate database servers and preferably stored in at least one database independent of the databases controlled by the reservation system companies and communicatively coupled to a web server. In such circumstances, a local query on RS 1 or RS 2 is suitably performed rather than querying, or pinging, a reservation system database.

Flow progresses to decision block 408 where a determination is made whether any of the public fares resulting from the queries performed in processes 400 and 402 are different. A positive determination at decision block 408 results in progression to process 410 where the lower of the two available fares is selected. Flow then progresses to process block 412 where the originating database for the lower fare is determined. After determining the originating database in process 412, it becomes possible to determine whether the selected lower public fare is subject to change within a short period of time. Therefore, progression flows to decision block 414 where a determination is made whether the fare originated from the most recently updated database RS 1 or RS 2.

A negative determination at decision block 414 means that the lower fare is older than the newer fare and will only exist until the originating database performs its next update. Generally, this time period is less than one hour. Therefore, progression flows to process block 416 where the fare is tagged as a temporary fare so that the end user can be notified that the fare will not be available much longer. Progression then flows to process block 418 where the fare is validated.

Upon a positive determination at decision block 414, flow progresses to process block 418 where the fare is validated. For example, as previously discussed, certain airports within close proximity to one another potentially cause glitches in the reservation systems. Therefore, if an origin or destination location falls within one of the locations having potential problems with airports, the system suitably validates the fare by querying the originating RS for the number of flights on the day of the fare from the selected origin airport to the selected destination airport. If the originating RS returns zero nonstops, zero onestops, and zero connection flights between the two airports, the fare is invalid. Otherwise, the fare is valid. After returning from a query and validating at least one fare, progression flows to process 420 where fare selection occurs.

In the presently preferred embodiment, all available public fares are sorted by airline and then by price. At least the lowest fare from the user-selected origin location to the user-selected destination location for each airline is selected. The public fares database is suitably queried such that fares for travel at least thirty days in advance are retrieved because the thirty day advance fares tend to be lower than those fares with shorter advance purchase. In the presently preferred embodiment, the reservations system databases RS 1 and RS 2 are queried for all fares from the present date up to thirty days beyond the present date plus the number of remaining days until the next Tuesday after the thirty days. The rational for the present query design is that Tuesday fares are often lower fares than Monday fares, even if both fares are more than thirty days advance purchase fares.

In the presently preferred embodiment, the two lowest public fares per airline and all public fares less than or equal to a predetermined dollar amount more than the lowest fare are stored. In the presently preferred embodiment, the predetermined dollar amount is $50. In addition, at least the public lowest fare for each combination of alternate origin and destination locations is stored. Also in the presently preferred embodiment, the two lowest public fares regardless of airline and all fares less than or equal to a predetermined dollar amount more than the lowest fare are stored.

After storing at least one lowest public fare, the various rules that accompany the public fares are applied to each of the stored fares. The application of the rules preferably involves querying the rules database to determine the rules for a selected fare. The application of rules to the public fares suitably involves, in an alternate embodiment, the reservation system from which the fare was retrieved is suitably queried. However, querying the reservation system is a slower process and incurs additional charges, so it is preferable to avoid querying the reservation systems whenever possible.

In addition to querying RS 1 and RS 2 in processes 400 and 402, respectively, the Internet only fares database is queried in process 406 for the same combinations of origin locations and destination locations as are queried in processes 400 and 402. The Internet only fares database is suitably a public or members-only section of the web site. In the presently preferred embodiment, the Internet only database is a public section of the web site. Internet only database is searched in the same manner as the RS 1 and RS 2 databases utilizing the same advance purchase criteria. The results of the Internet only fares are suitably displayed for user selection.

Also in addition to querying RS 1 and RS 2 in processes 400 and 402, respectively, the private fares database is queried in process 304 for the same combinations of origin locations and destination locations as are queried in processes 400 and 402. The private fares database comprises special fares and suitably includes contract fares with airlines and percentage discounts offered by the airlines to the web service provider. The private fares section is suitably accessible to members only. While the public fare databases are queried for all fares up to thirty days advance purchase plus the next Tuesday, the private fare database is queried for a plurality of advance purchase categories and organized by advance purchase category. In the presently preferred embodiment, the private fares database is queried for advance purchase days of 0, 3, 7, 10, 14, 21 and 30. Results of all queries are then stored and private database rules are applied to the results. In a presently preferred embodiment, at least one fare from each of the advance purchase categories is selected for displaying to the user. After the member fares are retrieved for all origin and destination locations, the results of the private fare search for alternate origin and destination location fares are suitably combine with the public fare search for alternate origin and destination location fares. In such instances, the single lowest available fare, private or public for each alternate origin to destination location is suitably displayed. This method is suitably also used to query multiple databases to find the lowest hotel rate and car rental rate.

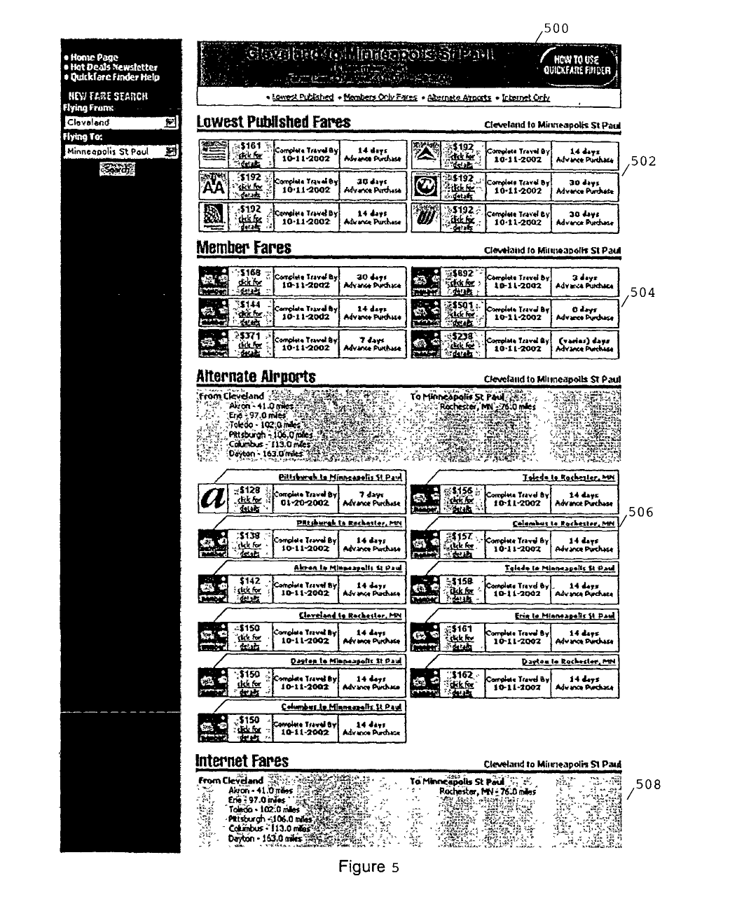

Turning now to FIG. 5, a portion of a web page for displaying query results responsive to user input is disclosed. The results web page 500 suitably comprises information relating to published fares, member fares, fares from alternate airports and Internet only fares. In a presently preferred embodiment, the lowest published fares section 502 displays one lowest published fare per airline for a selected group of airlines, hotels, or car rental agencies. A members fares section 504 suitably displays a list of private or members only fares for each of the advance purchase categories of 0, 3, 7, 14, 21, and 30 days for each of the categories available in the private fares database. In addition, the members fares section suitable displays members fares having variable advance purchase requirements.

Another portion of the web page for displaying query results responsive to user input is an alternate airport section or location 506. The results of the queries for alternate origin and destination location fares are displayed in this section. The section suitably comprises information relating to published or public fares, members only fares, or both. Also, the results page 500 comprises a section for displaying Internet only fares 508. Whenever Internet only fares are available from a selected or alternate origin to a selected or alternate destination, the Internet only fares section 508 displays the available fares. Like the alternate fares section, the Internet only fares section suitably displays published or public fares, members only fares, or both. Similar displays are suitably used to display hotel rates and car rental rates.

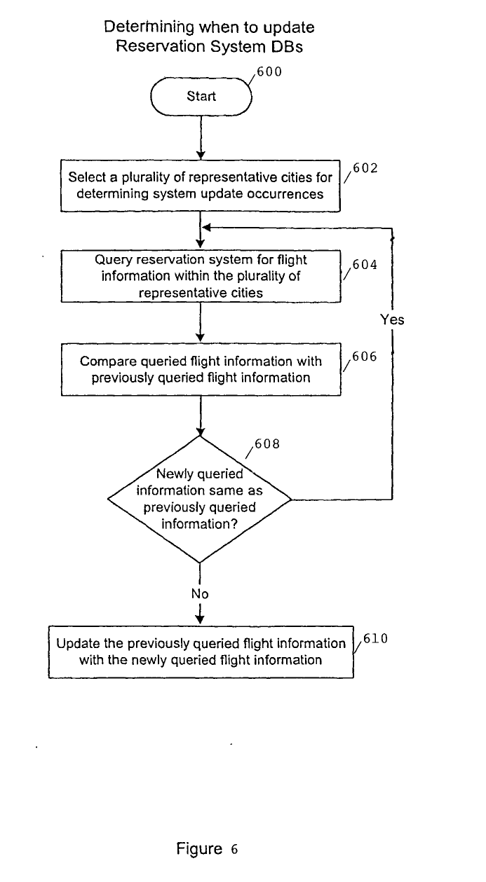

Turning now to FIG. 6, a flow chart describing an overall method for updating information from reservation system databases is disclosed. As discussed above, not all reservation systems inform their subscribers when the system has been updated. Therefore, in order to determine whether one has the most recent and updated local copy of such reservation systems, a system for determining update occurrences must be in place. While FIG. 6 illustrates a method for updating airline fares, the method is suitably also used to update hotel rates and car rental rates. The basic flow commences at start block 600, from which progress is made to process block 602 in which a plurality of representative cities or pairs of cities are selected for monitoring in order to determine system update occurrences.

Flow then progresses to process block 604 where the reservation system is queried for fare information for flights departing or arriving in representative cities. In the case of representative city pairs, the reservation system is queried for flights from one city in the city pair to the other city in the city pair. The reservation system may also be queried for information relating to hotel rates or car rental rates. The information from the query is then stored, preferably in a local database. In the presently preferred embodiment, the reservation system is queried at regular time intervals, preferably ten minute intervals.

After storing the information from the query, the newly stored information is compared to the information stored during the last query in process block 606. Flow then progresses to decision block 608 where a determination is made whether the newly stored information matches the information stored during the last query. A positive determination at decision block 608 causes progression back to process block 604 where the reservation system is queried again.

A negative determination at decision block 608 means that an update has occurred, and that the information in the reservation system has changed. While any change in fare information signals an update, the presently preferred embodiment looks to the fare code and cost information to determine change in decision block 608. Flow then progresses to process block 610 where a complete system update is initiated so that the local copy of the reservation system information matches the current reservation system information.

In addition, during a full update, the system suitably analyzes how many markets changed. If a large number of markets change, a major update has taken place and a delay is introduced such that the system does not query the reservation system prior the completion of the reservation system's update. The update system also suitably analyze all errors from reservations system whenever the reservation system experiences technical difficulty. In the case of major reservation system failure, a threshold test is suitably employed to notify all relevant contacts that unrecoverable errors have occurred.

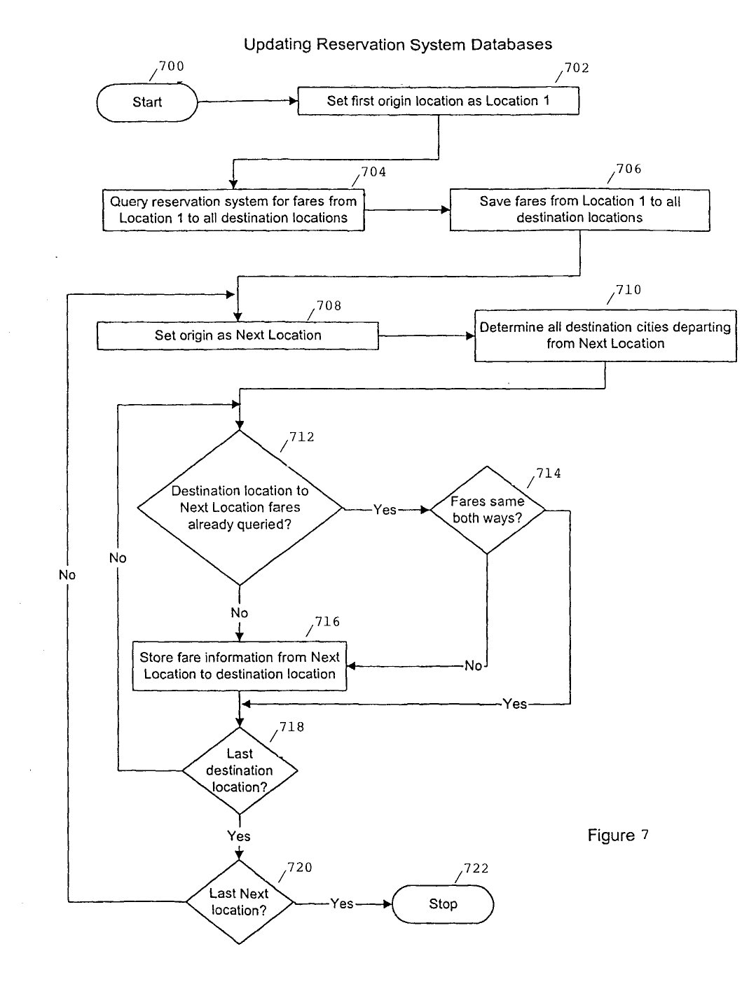

Turning now to FIG. 7, a flowchart representing a method for updating information in the RS database with information from at least one of the RS servers is disclosed. It should be noted that the flow chart in FIG. 7 is one example of a methodology for updating one database with information from another. Another such method not disclosed in FIG. 7 involves the use of multithreaded parallel processing where both reservation systems are queried in a multithreaded fashion and are combined in a fare processor. Such processing captures a more simplified flow. While FIG. 7 illustrates a method for updating information for airline fares, the method is suitably also used to update hotel rates and car rental rates.

The basic flow commences at start block 700 and proceeds to process block 702 where the first origin location for updating is set as Location 1. Flow then progresses to process block 704 where the reservation system is queried for all destination locations for flights originating in Location 1. All fares from Location 1 to all destination locations are then stored in process 606.

Flow then progresses to process block 708 where the origin location is set to Next Location, after which progression flows to process block 710 where the reservation is again queried for all destination cities, but this time for those locations departing from Next Location. After storing the fares for all destination locations for flights departing from Next Location, flow progresses to decision block 712 wherein a determination is made for each destination location whether a flight has already been queried having an origin as the destination location and a destination as Next Location.

A positive determination at decision block 712 causes progression to decision block 714 wherein a further determination is made whether the fares from the Next Location to destination location are the same as the fares from destination location to Next Location. A negative determination at decision block 714 causes progression to process block 716 where the fare information for flights from Next Location to destination location is stored. Likewise, a negative determination at decision block 712 causes progression to process block 716.

A positive determination at decision block 714 causes progression to decision block 718 wherein a determination is made whether current destination location is the last destination location that needs to be updated for the current Next Location. A negative determination at decision block 718 causes a loop back to decision block 712 for the next destination location. A positive determination at decision block 718 causes progression to decision block 720 where a determination is made whether the current Next Location is the last Next Location that needs to be updated. A negative determination causes a loop back to process block 708 where a new Next Location is set to the origin location. A positive determination at decision block 720 causes progression to termination block 722.

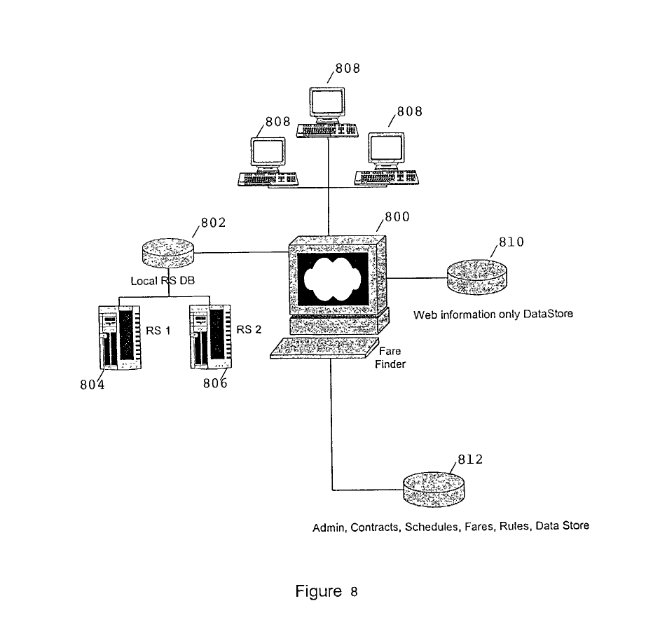

Another embodiment of the system for compiling and providing information relating to airline fares, hotel rates, and car rental rates is shown in FIG. 8. As with the system shown in FIG. 1, the system is suitably a network system and preferably comprises a web server 800 that is accessible to end user machines 708 via the Internet. The web server 800 preferably provides access to information stored in at least one database by providing information that is accessible from an Internet browser program such as Netscape or Internet Explorer. Preferably, the web server 800 comprises markup language based web pages (i.e. HTML, XML, etc.) and server pages (i.e. JSP, ASP, etc.).

Communicatively coupled to web server 800 is an RS database 802. The RS database 802 is suitably any database for storing information received from at least one RS server 804 or 806. Preferably, the RS database 802 is a relational database comprising multiple interrelated tables that store information retrieved from querying at least one RS server 804 or 806. The RS database is suitably a set of tables residing either on the web server 800 or on an independent server. In addition, the RS database 802 suitably comprises separate databases designed to store information retrieved from separate RS servers 804 and 806. Furthermore, the RS database suitably comprises separate database servers each configured to store information from separate RS servers 804 and 806.

Also communicatively coupled to web server 800 is an web information only data store 810 for storing information about fares from the Internet. The web information only data store 810 is suitably any data store for storing information relating to Internet only fares or rates offered by at least one airline, hotel, or car rental agency. With regard to air fares, preferably, the web information only data store 810 contains information relating to all domestic airlines and at least a subset of the international airlines. Preferably, the web information only datastore 810 is a relational database comprising multiple interrelated tables that store information relating to Internet only fares or rates. The web information only data store 810 is suitably a set of tables residing either on the web server 800 or on an independent server. In addition, the web information only datastore 810 suitably comprises separate databases designed to store information regarding Internet only fares from separate airlines, hotels, and car rental agencies.

Also communicatively coupled to the web server 800 is an administrative data store 812 for storing the rules associated with various fare codes, administrative information, contract information, fare information, and schedule information. When a reservation system is queried, fare information obtained comprises a fair code or rate code for each fare or rate. Associated with fare codes are sets of rules that further limit the availability of the fare. Such rule information associated with fare codes is stored in the administrative datastore 812. Preferably, the administrative datastore 812 is a relational database comprising multiple interrelated tables that store information relating to rules corresponding to fare codes. The administrative datastore 812 is suitably a set of tables residing either on the web server 800 or on an independent server. In addition, the administrative datastore 812 suitably comprises separate databases designed to store information regarding rules from separate airlines, hotels, and car rental agencies. Such rules include, but are not limited to, day of travel restrictions, time restrictions, seasonal restrictions, blackout periods, minimum stay requirements, maximum stay requirements, advance purchase requirements, stopovers, and senior fares. The administrative datastore 812 also suitably comprises separate database servers each configured to store rule information from separate airlines, hotels, and car rental agencies.

The administrative datastore 812 stores information related to administrative functions. The administrative datastore 812 further stores information related to schedules and fares. The administrative datastore 812 also stores information related to contracts with the airlines. Preferably, the administrative datastore 812 stores information relating to fares, schedules, and rules for flights up to 330 days in the future.

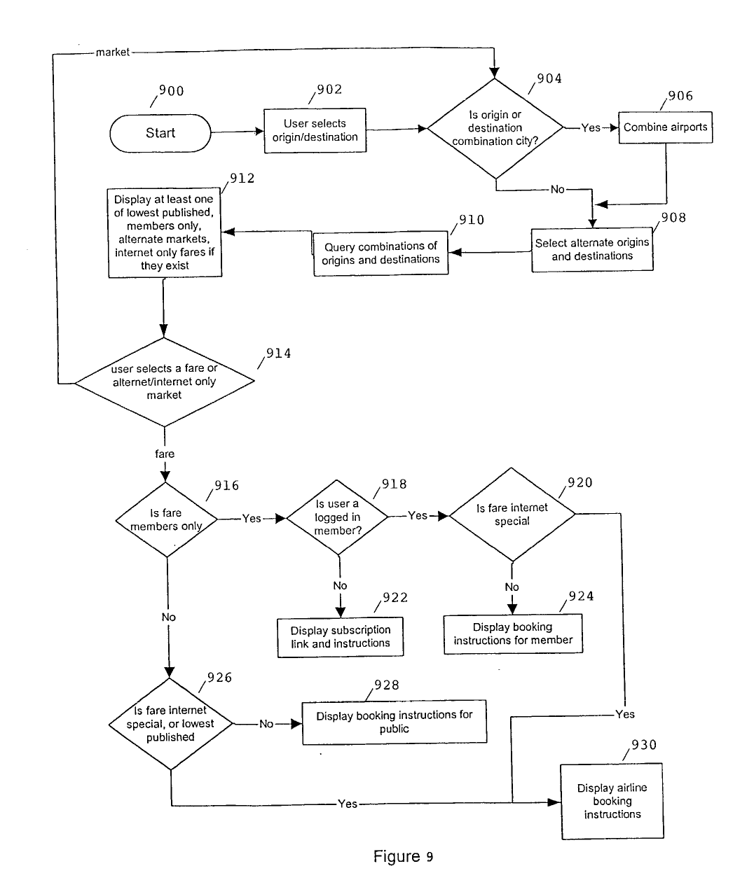

Turning now to FIG. 9, a flow chart representing an alternative method for displaying at least one low fare corresponding to an input request by a user is disclosed. While FIG. 9 illustrates a method for displaying airline fares, the method is suitably also used to display hotel rates and car rental rates.

The basic flow commences at start block 900, from which progress is made to process block 902 where a user selects an origin and a destination on a web page. Flow then proceeds to decision block 904 where a determination is made whether either the selected origin or destination city are combination locations as described with respect to the embodiment shown in FIG. 2.

Therefore, upon a positive determination in decision block 904, flow progresses to process block 906 where the airport codes for multiple airports in a combination location are combined into a single location code. Flow then proceeds to process block 908 where alternate origins and destinations are retrieved. Upon a negative determination at decision block 904, flow progresses directly to process block 908. Alternate origins and destinations are those locations within close proximity such that a user may desire to travel to the alternate location in order to reduce airfare. The alternate locations retrieved in process block 908 are suitably preselected and stored in a locations table or database or determined based on distance or time criteria either entered by the user or automated by the system. In a presently preferred embodiment, five alternate locations are selected, however any number of locations are within the scope of the present invention. Also, in a presently preferred embodiment, the alternate locations are selected without forcing the user to enter any additional information.

Flow then proceeds to process block 910 where fare for all combinations from the list of origin and alternate origin locations to the destination and alternate destinations are queried. If the desired fare is one-way, then fares from all origin locations to all destination locations are queried. If the desired fare is round-trip, then the fares are queried such that the destination location of the first trip is the origin location of the return trip and origin location of the first trip is destination location of the return trip. After querying the fares for the various combinations of locations, at least one of the lowest published fare, members only fare, alternate market fare, and Internet only fare is displayed for the user in process block 912.

Flow proceeds to decision block 914 where a user either selects a displayed fare or chooses to look for alternate markets or Internet only fares. If the user chooses to look for fares alternate markets or Internet only fares, the process returns to decision block 904 and the process proceeds for only those fares.

If the user selects a displayed fare, flow progresses to decision block 916 where a determination is made whether the selected fare is a members only fare. A negative determination at decision block 916 causes progression to decision block 926 where a determination is made whether the fare selected at process 914 is an Internet only fare. Upon a negative determination at decision block 926, flow progresses to process block 928 where instructions for booking the fare are displayed for the non-member user. A positive determination at decision block 926 causes progression to process block 930 where the instructions specific to a particular airline's Internet only fare are displayed for the user. The display of the Internet only fare booking instructions is suitably accomplished by linking the user to the airline's web site for booking the fare.

Upon a positive determination at decision block 916, flow progresses to decision block 918 where a determination is made whether the user is logged in as a member. Upon a negative determination at decision block 918 causes progression to decision block 922 where instructions for becoming a member are displayed for the user.

A positive determination at decision block 918 causes progression to decision block 920 where a determination is made whether the fare is an Internet only fare. Upon a negative determination at decision block 920, progression is made to process block 924 where instructions for booking the fare are displayed for the member user. A positive determination at decision block causes progression to process block 930 where the instructions specific to a particular airline's Internet only fare are displayed for the user as described above.

Appendix A attached hereto illustrates a preferred database schema of the present invention.

It will be appreciated that various changes in the details, materials and arrangements of parts which have been herein described and illustrated in order to explain the nature of the invention may be made by those skilled in the area within the principle and scope of the invention.

[image]

[image]

[image]

[image]

[image]

[image]

[image]

What is claimed is:

1. A method for querying and displaying airline fare information comprising the steps of:
selecting an origin location and a destination location;
selectively querying at least one database for fares for the received origin and destination location combination;
displaying selected information relating to fares for the received origin location and destination location combination;
determining whether at least one alternate location is available;
based on a positive determination that at least one alternate location is available, selecting at least one alternate location;
selectively querying at least one database for fares for the received origin, destination, and at least one alternate location combination; and
displaying selected information relating to fares for at least one location combination comprising the least one alternate location.

2. The method according to claim 2 wherein the at least one alternate location is a location located proximate to at least one of the origin location and the destination location.

3. The method according to claim 1 wherein the at least one alternate location is selected based on predetermined criteria.

4. The method according to claim 1 further comprising the steps of:
selecting, by receiving input from an end user, at least one displayed fare;
determining if the selected fare is a fare which is available only to a selected group of end users,
based on a positive determination that the fare is only available to a selected group, determining if the end user is a member of the selected group;
based on a negative determination that the end user is not a member, displaying selected information for becoming a member;
based on a positive determination that the end user is a member, determining if the selected fare is available only by booking the fare via the Internet;
based on a positive determination that the selected fare is only available via the Internet, displaying selected information about airline Internet fare booking procedures for the airline associated with the selected fare; and
based on a negative determination that the selected fare is only available by booking the fare via the Internet, displaying selected information about booking instructions for members of the selected group.

5. The method according to claim 4 further comprising the steps of:
based on a negative determination that the fare is only available to members of a selected group, determining if the fare is available only by booking the fare via the Internet;
based on a positive determination that the fare is only available by booking the fare via the Internet, displaying selected information about airline Internet fare booking procedures for the airline associated with the selected fare; and
based on a negative determination that the fare is only available by booking the fare via the Internet, displaying selected information about booking instructions for non-members.

6. The method according to claim 1 further comprising the step of displaying at least one of lowest published fares, fares available only to members of a select group, fares available for at least one alternate location, and fares available only by booking the fare via the Internet.

7. The method according to claim 1 further comprising the steps of:
selectively querying at least two databases for fares for the received origin, destination location, and, if available, at least one alternate location, combination;
determining if fares received from each database are different;
based on a positive determination that the fares received are different, selecting at least the lowest fare and associating such fare with the database from which such fare was received;
determining if the database from which at least the lowest fare was received has been recently updated;
based on a negative determination that the database has been recently updated, classifying the fare as temporary, and notifying the user that the fare is temporary;
determining if at least the lowest fare is valid; and
based on a positive determination that the fare is valid, displaying selected information about at least the lowest fare.

8. The method according to claim 7 further comprising the steps of:
selectively querying at least one of a database of fares available only to members of a selected group and a database of fares available only by booking the fares via the Internet for the received origin, destination location, and, if available, at least one alternate location, combination;
determining if the received fares are valid; and
based on a positive determination, selecting at least the lowest fare received; and
displaying selected information about the lowest fare.

9. A system for querying and displaying airline fare information comprising:
means adapted for selecting an origin location and a destination location;
means adapted for selectively querying at least one database for fares for the received origin and destination location combination;
means adapted for displaying selected information relating to fares for the received origin location and destination location combination;
means adapted for determining whether at least one alternate location is available;
based on a positive determination that at least one alternate location is available, means adapted for selecting at least one alternate location upon determining that at least one alternate location is available;
means adapted for selectively querying at least one database for fares for the received origin, destination, and at least one alternate location combination; and
means adapted for displaying selected information relating to fares for at least one location combination comprising the least one alternate location.

10. The system according to claim 9 wherein the at least one alternate location is a location located proximate to at least one of the origin location and the destination location.

11. The system according to claim 9 wherein the at least one alternate location is selected based on predetermined criteria.

12. The system according to claim 9 further comprising:
means adapted for selecting, by receiving input from an end user, at least one displayed fare;
means adapted for determining if the selected fare is a fare which is available only to a selected group of end users,
based on a positive determination that the fare is only available to a selected group, means adapted for determining if the end user is a member of the selected group;
based on a negative determination that the end user is not a member, means adapted for displaying selected information for becoming a member;
based on a positive determination that the end user is a member, means adapted for determining if the selected fare is available only by booking the fare via the Internet;
based on a positive determination that the selected fare is only available via the Internet, means adapted for displaying selected information about airline Internet fare booking procedures for the airline associated with the selected fare; and
based on a negative determination that the selected fare is only available by booking the fare via the Internet, means adapted displaying selected information about booking instructions for members of the selected group.

13. The system according to claim 12 further comprising:
based on a negative determination that the fare is only available to members of a selected group, means adapted for determining if the fare is available only by booking the fare via the Internet;
based on a positive determination that the fare is only available by booking the fare via the Internet, means adapted for displaying selected information about airline Internet fare booking procedures for the airline associated with the selected fare; and
based on a negative determination that the fare is only available by booking the fare via the Internet, means adapted for displaying selected information about booking instructions for non-members.

14. The system according to claim 8 further comprising means adapted for displaying at least one of lowest published fares, fares available only to members of a select group, fares available for at least one alternate location, and fares available only by booking the fare via the Internet.

15. The system according to claim 9 further comprising:
means adapted for selectively querying at least two databases for fares for the received origin, destination location, and, if available, at least one alternate location, combination;
means adapted for determining if fares received from each database are different;
based on a positive determination that the fares received are different, means adapted for selecting at least the lowest fare and associating such fare with the database from which such fare was received;
means adapted for determining if the database from which at least the lowest fare was received has been recently updated;
based on a negative determination that the database has been recently updated, means adapted for classifying the fare as temporary and notifying the user that the fare is temporary;
means adapted for determining if at least the lowest fare is valid; and
based on a positive determination that the fare is valid, means adapted for displaying selected information about at least the lowest fare.

16. The system according to claim 15 further comprising:
means adapted for selectively querying at least one of a database of fares available only to members of a selected group and a database of fares available only by booking the fares via the Internet for the received origin, destination location, and, if available, at least one alternate location, combination;
means adapted for determining if the received fares are valid; and
based on a positive determination, means adapted for selecting at least the lowest fare received; and
means adapted for displaying selected information about the lowest fare.

17. A method for querying and displaying travel rate information for at least one of hotel rates and car rental rates comprising the steps of:
selecting a travel destination;
selectively querying at least one database for rates associated with the selected destination
displaying selected information relating to fares associated with the selected destination;
determining whether at least one alternate location is available;
based on a positive determination that at least one alternate location is available, selecting at least one alternate location;
selectively querying at least one database for fares associated with the destination location and at least one alternate location combination; and
displaying selected information relating to fares associated with at least one location combination comprising the least one alternate location.

18. The method according to claim 17 further comprising the steps of:
selecting, by receiving input from an end user, at least one displayed fare;
determining if the selected fare is a fare which is available only to a selected group of end users,
based on a positive determination that the fare is only available to a selected group, determining if the end user is a member of the selected group;
based on a negative determination that the end user is not a member, displaying selected information for becoming a member;
based on a positive determination that the end user is a member, determining if the selected fare is available only by booking the fare via the Internet;
based on a positive determination that the selected fare is only available via the Internet, displaying selected information about Internet fare booking procedures for the entity associated with the selected fare; and
based on a negative determination that the selected fare is only available by booking the fare via the Internet, displaying selected information about booking instructions for members of the selected group.

19. The method according to claim 18 further comprising the steps of:
based on a negative determination that the fare is only available to members of a selected group, determining if the fare is available only by booking the fare via the Internet;
based on a positive determination that the fare is only available by booking the fare via the Internet, displaying selected information about Internet fare booking procedures for the entity associated with the selected fare; and
based on a negative determination that the fare is only available by booking the fare via the Internet, displaying selected information about booking instructions for non-members.

20. The method according to claim 17 further comprising the step of displaying at least one of lowest published fares, fares available only to members of a select group, fares available for at least one alternate location, and fares available only by booking the fare via the Internet.

21. The method according to claim 17 further comprising the steps of:
selectively querying at least two databases for fares for the selected destination and, if available, at least one alternate location, combination;
determining if fares received from each database are different;
based on a positive determination that the fares received are different, selecting at least the lowest fare and associating such fare with the database from which such fare was received;
determining if the database from which at least the lowest fare was received has been recently updated;
based on a negative determination that the database has been recently updated, classifying the fare as temporary, and notifying the user that the fare is temporary;
determining if at least the lowest fare is valid; and
based on a positive determination that the fare is valid, displaying selected information about at least the lowest fare.

22. The method according to claim 21 further comprising the steps of:
selectively querying at least one of a database of fares available only to members of a selected group and a database of fares available only by booking the fares via the Internet for the received origin, destination location, and, if available, at least one alternate location, combination;
determining if the received fares are valid; and
based on a positive determination, selecting at least the lowest fare received; and
displaying selected information about the lowest fare.

23. A system for querying and displaying travel rate information for at least one of hotel rates and car rental rates comprising the steps of:
means adapted for selecting a travel destination;
means adapted for selectively querying at least one database for rates associated with the selected destination
means adapted for displaying selected information relating to fares associated with the selected destination;
means adapted for determining whether at least one alternate location is available;
based on a positive determination that at least one alternate location is available, means adapted for selecting at least one alternate location;
means adapted for selectively querying at least one database for fares associated with the destination location and at least one alternate location combination; and
means adapted for displaying selected information relating to fares associated with at least one location combination comprising the least one alternate location.

24. The system according to claim 23 further comprising:
means adapted for selecting, by receiving input from an end user, at least one displayed fare;
means adapted for determining if the selected fare is a fare which is available only to a selected group of end users,
based on a positive determination that the fare is only available to a selected group, means adapted for determining if the end user is a member of the selected group;
based on a negative determination that the end user is not a member, means adapted for displaying selected information for becoming a member;
based on a positive determination that the end user is a member, means adapted for determining if the selected fare is available only by booking the fare via the Internet;
based on a positive determination that the selected fare is only available via the Internet, means adapted for displaying selected information about Internet fare booking procedures for the entity associated with the selected fare; and
based on a negative determination that the selected fare is only available by booking the fare via the Internet, means adapted for displaying selected information about booking instructions for members of the selected group.

25. The system according to claim 24 further comprising:
based on a negative determination that the fare is only available to members of a selected group, means adapted for determining if the fare is available only by booking the fare via the Internet;
based on a positive determination that the fare is only available by booking the fare via the Internet, means adapted for displaying selected information about Internet fare booking procedures for the entity associated with the selected fare; and
based on a negative determination that the fare is only available by booking the fare via the Internet, means adapted for displaying selected information about booking instructions for non-members.

26. The system according to claim 23 further comprising means adapted for displaying at least one of lowest published fares, fares available only to members of a select group, fares available for at least one alternate location, and fares available only by booking the fare via the Internet.

27. The system according to claim 23 further comprising:
means adapted for selectively querying at least two databases for fares for the selected destination and, if available, at least one alternate location, combination;
means adapted for determining if fares received from each database are different;
based on a positive determination that the fares received are different, means adapted for selecting at least the lowest fare and associating such fare with the database from which such fare was received;
means adapted for determining if the database from which at least the lowest fare was received has been recently updated;
based on a negative determination that the database has been recently updated, means adapted for classifying the fare as temporary and notifying the user that the fare is temporary;
means adapted for determining if at least the lowest fare is valid; and
based on a positive determination that the fare is valid, means adapted for displaying selected information about at least the lowest fare.

28. The method according to claim 27 further comprising:
means adapted for selectively querying at least one of a database of fares available only to members of a selected group and a database of fares available only by booking the fares via the Internet for the received origin, destination location, and, if available, at least one alternate location, combination;
means adapted for determining if the received fares are valid; and
based on a positive determination, means adapted for selecting at least the lowest fare received; and
means adapted for displaying selected information about the lowest fare.

29. A method for monitoring updates to a reservation system database comprising the steps of:
selecting at least one representative location;
selectively querying the reservation system database at predetermined intervals for at least one of fares associated the at least one representative location;
determining if the fares received from the most recent query are the same as fares received from the next most recent query;
based on a negative determination, updating a local copy of the reservation system database with selected information about the new fares.

30. A system for monitoring updates to a reservation system database comprising:
means adapted for selecting at least one representative location;
means adapted for selectively querying the reservation system database at predetermined intervals for fares associated with the at least one location;
means adapted for determining if the fares received from the most recent query are the same as fares received from the next most recent query;
based on a negative determination, means adapted for updating a local copy of the reservation system database with selected information about the new fares.

31. A method for updating information in at least one reservation system database comprising the steps of:
selecting an origin location;
selectively querying at least one reservation system server for fares for all destination locations originating from the origin location;
selectively querying at least one reservation system server for fares departing from the origin location;
determining whether, for each destination location, if a query of the reservation system server has been performed for fares from the destination location to the origin location;
based on a negative determination that the reservation system server has been queried for fares from the destination location to the first location, storing selected fare information received from the selective query of for fares departing from the origin location in the reservation system database;
based on a positive determination that the reservation system server has been queried, determining whether the fare received for the origin location to the destination location is the same as the fare received for the destination location to the origin location; and
based on a negative determination that the fares are the same, storing selected fare information received from the selective query of for fares departing from the origin location for in the reservation system database.

32. The method according to claim 31 wherein a plurality of origin locations are selected.

33. A system for updating information in at least one reservation system database comprising:
means adapted for selecting an origin location;
means adapted for selectively querying at least one reservation system server for fares for all destination locations originating from the origin location;
means adapted for selectively querying at least one reservation system server for fares departing from the origin location;
means adapted for determining whether, for each destination location, if a query of the reservation system server has been performed for fares from the destination location to the origin location;
based on a negative determination that the reservation system server has been queried for fares from the destination location to the first location, means adapted for storing selected fare information received from the selective query of for fares departing from the origin location in the reservation system database;
based on a positive determination that the reservation system server has been queried, mean adapted for determining whether the fare received for the origin location to the destination location is the same as the fare received for the destination location to the origin location; and
based on a negative determination that the fares are the same, means adapted for storing selected fare information received from the selective query of for fares departing from the origin location for in the reservation system database.

34. The system according to claim 33 wherein a plurality of origin locations are selected.
